(19) United States
(12) Patent Application Publication
(10) Pub. No.: US 2023/0383763 A1
(43) Pub. Date: Nov. 30, 2023

(54) DOWNSTREAM GUIDE DEVICE AND FAN WITH DOWNSTREAM GUIDE DEVICE

(71) Applicant: ebm-papst Mulfingen GmbH & Co. KG, Mulfingen (DE)

(72) Inventors: Oliver HAAF, Kupferzell (DE); Thorsten PISSARCZYK, Gemmingen (DE); Daniel GEBERT, Oehringen (DE); Patrick HEINECKE, Lauda-Koenigshofen (DE)

(21) Appl. No.: 18/201,518

(22) Filed: May 24, 2023

(30) Foreign Application Priority Data
May 24, 2022 (DE) 10 2022 113 141.6
May 24, 2022 (DE) 10 2022 113 142.4

(51) Int. Cl. F04D 29/38

(52) U.S. Cl. CPC F04D 29/384

(57) ABSTRACT

The disclosure relates to a fan and a downstream guide device for a fan, the downstream guide device having a plurality of spoilers arranged in a star shape at a central position, each with a leading edge and a trailing edge, the spoiler having a jagged or wavy leading edge with a periodically repeating waveform at least in a portion.

### RELATED APPLICATIONS

This application claims priority to German Patent Application Nos. 10 2022 113 141.6 and 10 2022 113 142.4, both filed May 24, 2022, the entire contents of which are incorporated herein by reference in their entirety.

### FIELD

The present disclosure relates to a downstream guide device and to a fan with a downstream guide device, particularly to a centrifugal fan, an axial fan, or a diagonal fan having such a downstream guide device.

### BACKGROUND

Fans are used in many areas. There are many applications in which the air flow is highly turbulent. The turbulent outflow from the fan results in a substantial increase in noise emissions, which means annoying noise generation. In today's fans or fan wheels, fan blades that are favorably shaped in terms of flow mechanics enable high performance, particularly with regard to the flow volume achieved or pressure build-up. There exists a fundamental need for low-noise fans which also have good aerodynamics despite turbulent flow. However, high noise generation during operation of a fan, particularly that caused by rotor-stator interaction, remains problematic.

There are various design measures in the prior art for mitigating these problems. Many solutions deal with the blade shape of the fan blades. To reduce running noise, publication DE 19948075 A uses an axial fan with blades having a double-swept leading blade edge with a protruding outer corner. U.S. Pat. No. 3,416,725 A shows a blade shape with a double-swept leading edge and a slightly single-swept trailing edge.

DE 10326637 B3 describes a further solution, namely a fan with alternating direction of rotation having S-shaped double-swept blades with the leading edge receding sharply outward. Jagged or wavy trailing edges are used to reduce trailing edge noise (e.g., GB 2497739 or EP 1801422 A2). DE 102009044824 A1 uses porosities in the form of holes in the vicinity of the trailing edge to reduce the generation of noise at the trailing edge. Wavy or jagged leading edges are also known as a means of reducing noise in turbulent flow.

### BRIEF SUMMARY

The above-noted solutions deal with the blade shape of the fan blades. However, the present disclosure provides alternative solutions that are desirable and which bring about a technical effect in terms of smooth running and noise generation even with conventional fans (centrifugal fans, axial fans, or diagonal fans).

It is against this technical background that the disclosure approaches the problem of providing a fan that operates particularly with low noise.

The disclosure solves this problem with a fan according to the independent claims. The dependent claims contain advantageous refinements.

The disclosure relates to a solution consisting of an axial fan, diagonal fan, or centrifugal fan and to a downstream guide device that is modified according to the disclosure.

Before the disclosure is described in greater detail, some concepts and the terminology used will be explained in order to facilitate comprehension of the disclosure.

Within the meaning of the present disclosure, downstream guide devices are bladed guide vane assemblies that are arranged on the outflow side of the fan for air guidance.

Furthermore, a typical axial or diagonal fan is considered to usually have a plurality of fan blades arranged in a star shape on a central hub for aerodynamically sucking and/or pressing the air surrounding the fan or a gas that is to be conveyed by the fan. The fan blades can be connected to one another by a circumferential ring (slinger ring) on the radially outermost airfoil surface.

Furthermore, each fan blade has a front leading edge which leads during operation in the normal direction of rotation and a rear trailing edge which follows during operation of the fan in the normal direction of rotation. Furthermore, depending on the direction of rotation and the fan blade profile, there is a suction side and a pressure side, the suction side typically being on the convex side and the pressure side typically being on the concave side of the fan blade. As a rule, the leading and trailing edges are usually only optimally shaped for one direction of rotation. The fan blade blade therefore has a suction side, which sucks in the inflowing air during operation, and a pressure side opposite the suction side on which the pressure for discharging the air builds up. The downstream guide device follows on this side.

The leading edge of the respective spoiler of the downstream guide device thus faces toward the fan, whereas the trailing edge of the spoiler of the downstream guide device faces away from the fan.

It is a fundamental idea of the disclosure that, at least in some portions, the leading edge of the spoilers of the downstream guide device has a specific three-dimensional (or two-dimensional) wavy shape or has a correspondingly three- or two-dimensionally wavy design.

According to the disclosure, a downstream guide device for a fan is provided for this purpose, the downstream guide device having a plurality of spoilers which are preferably arranged in a star shape at a central position, e.g., around a central axis, each with a leading edge and a trailing edge, and whose airfoil profile is curved and/or twisted, the respective spoiler having a jagged or wavy leading edge with a preferably periodically repeating waveform at least in a portion. Alternatively, a non-periodic waveform can also be selected.

In one especially advantageous exemplary embodiment, a provision is made that the undulating pattern of the wave crests and wave troughs which is formed by the waveform extends substantially or completely in the plane formed by the respective spoiler in the vicinity of the leading edge and/or the wave crests extend substantially along a tangent along the surface of the spoiler in the vicinity of the respective wave crest. In other words, this means that the respective wave crest extends out from the blade edge in the extension of the airfoil profile and not, for instance, out of the surface of the airfoil of the spoiler, so that the leading edge as such has a wavy shape. In this respect, the surface geometry of the airfoil profile at the leading edge is not modified by the waveform according to the disclosure, but by the leading edge itself.

In a preferred exemplary embodiment of the disclosure, a provision is made that the wavy leading edge of the spoilers has a plurality or multiplicity of periodically repeating wavy portions or waveforms.

In an especially advantageous embodiment, the waveform of the leading edge of the spoilers can be described or approximated according to one of the following mathematical functions:
according to a sinusoidal or near-sinusoidal waveform or
according to a power function of the nth order, particularly of the form

f(x)=a·xn
in which a=f(r)
where a represents a function describing the extension of the tip as a function of the radius r and where n is preferably in a range between −5 and 5.

In the case of a wave or waveform that can be approximated by a power function or, alternatively, a polynomial function, the wave trough is advantageously rounded off.

In addition, it is favorable if the leading edge of the spoilers has a wavy or jagged edge shape substantially over the entire course of the blade but at least over a continuous portion of more than 20%, preferably more than 50% of the length of the spoilers as viewed in the radial direction or span direction.

Another variant is that the leading edge of the spoilers has regions with non-wavy edge profiles between or next to the wavy profiles, but that it has a profile at least over a continuous portion as described above.

A combination of multiple geometric design elements according to the disclosure is especially advantageous, with the waveform being characterized by at least one of the following design measures:
the progression of the angle of attack over the radius has two or more inflection points;
superposed variation of a periodic or non-periodic wave versus only a continuous (i.e., non-wavy) progression of the leading edge;
the chord length of the spoilers changes;
the airfoil sections are extended in the direction of the leading edge, particularly continuously;
the curvature of the spoilers changes in the vicinity of the leading edge.

In another preferred exemplary embodiment of the disclosure, a provision is made that the profile of the spoilers, as viewed at least in an airfoil section in the vicinity of a wave crest, has a bulge that protrudes from the top side and a dent that reaches in on the bottom side, or vice versa.

The present disclosure relates particularly to an axial or diagonal fan, as well as to a centrifugal fan, each of which has a downstream guide device as described above or one or more spoilers arranged downstream from the fan in the direction of flow.

The following advantages and features are associated with the disclosure. The special design of the leading edge of the downstream guide device with the modification described is fundamentally aimed at sound generation mechanisms other than modifications to the rear edge or trailing edge. The advantage of the disclosure, in contrast to the rear edge modification, is that it explicitly reduces the noise generated as a result of the interaction of the impeller and the guide wheel.

The leading edge modification described is also designed for axial or diagonal fans with a slinger ring. The leading edge modification described is also designed for centrifugal or diagonal fans with a shroud. The disclosure can also be used to reduce noise in typical flow situations (no head gap vortices, increased tangential components due to the closed ring, backflow in the outer region, and wake effects of the gap flow) and, in addition to the points mentioned below, minimize the noise by reducing the resulting interaction mechanisms.

The modification of the downstream guide device according to the disclosure has the following advantages, particularly in comparison to to the solutions that are known in the prior art:
Reduced sound power levels and reduced tonal components in the sound radiation are achieved. In addition to a reduced A-rating of the noise, the latter also contributes to an improvement in psychoacoustic perception.
The commonly used design that employs a strong sweep of the downstream guide device in order to achieve the acoustic target values can be replaced by a design with reduced sweep and modification of the leading edge according to the disclosure.
The possible reduction of the sweep leads to an increase in strength in a downstream guide device with a load-bearing function. The increased strength enables the material input to be reduced.
By virtue of the reduced blade length, a reduction in the sweep also means a reduction in the material requirements, even in the case of non-load-bearing downstream guide devices.
With the same noise level, the distance to the upstream impeller can be reduced by the modification described. This makes more compact fan units and/or an increase in the blade area of the downstream guide device possible and thus an increase in efficiency.

Other advantageous refinements of the disclosure are characterized in the subclaims and/or depicted in greater detail below together with the description of the preferred embodiment of the disclosure with reference to the figures.

### BRIEF DESCRIPTION OF THE DRAWINGS

FIG. 1 shows a first exemplary embodiment of a downstream guide device;

FIG. 2 shows a second alternative exemplary embodiment of a downstream guide device;

FIG. 3 shows a third exemplary embodiment of a downstream guide device;

FIG. 4 shows a fourth exemplary embodiment of a downstream guide device;

FIG. 5 shows a spoiler with a wavy leading edge; and

FIG. 6 shows a cut-out of a spoiler with a partially wavy leading edge.

### DETAILED DESCRIPTION

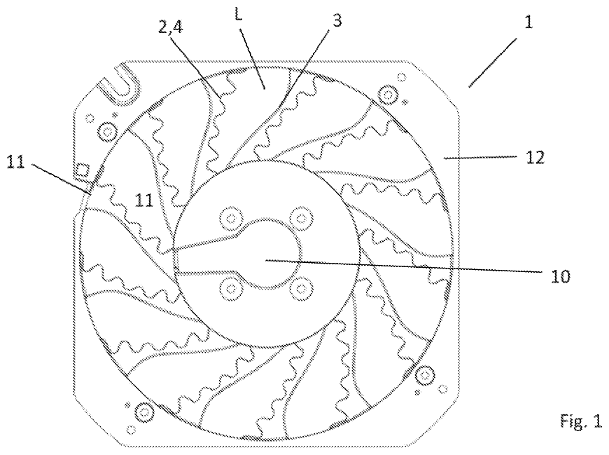

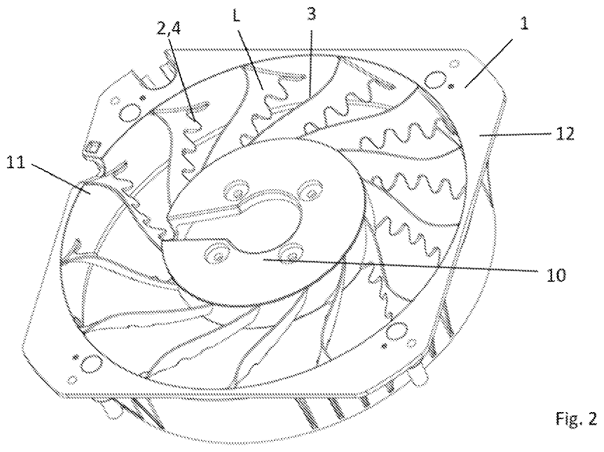

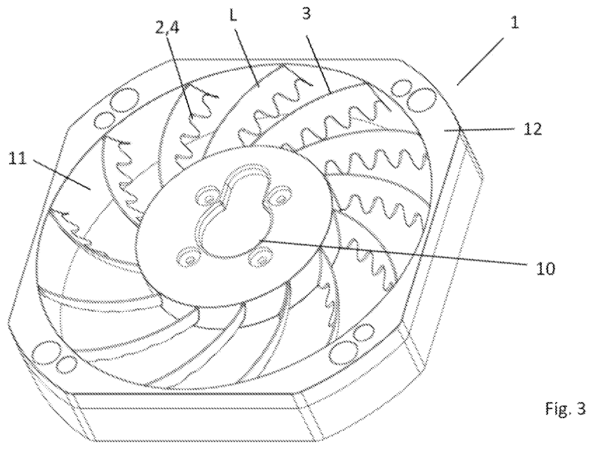

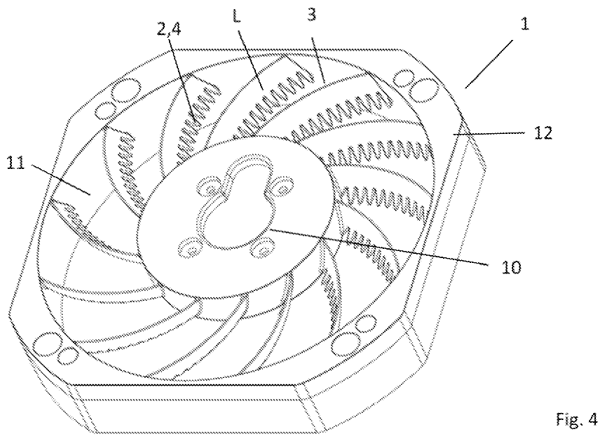

In the following, the disclosure will be explained in greater detail on the basis of an exemplary embodiment with reference to FIGS. 1 to 6, with same reference symbols in the figures referring to similar structural and/or functional features.

FIGS. 1 to 4 show alternative exemplary embodiments of a downstream guide device 1 with spoilers L, each with a wavy leading edge 2, 4.

The downstream guide devices 1 shown are designed for a fan, with the respective downstream guide device 1 having a plurality of spoilers L arranged in a star shape at a central position P, each with a leading edge 2, 4 (leading edge) and a trailing edge 3 (rear edge), the spoiler L having a respective jagged or wavy leading edge 4 with a waveform at least in a portion.

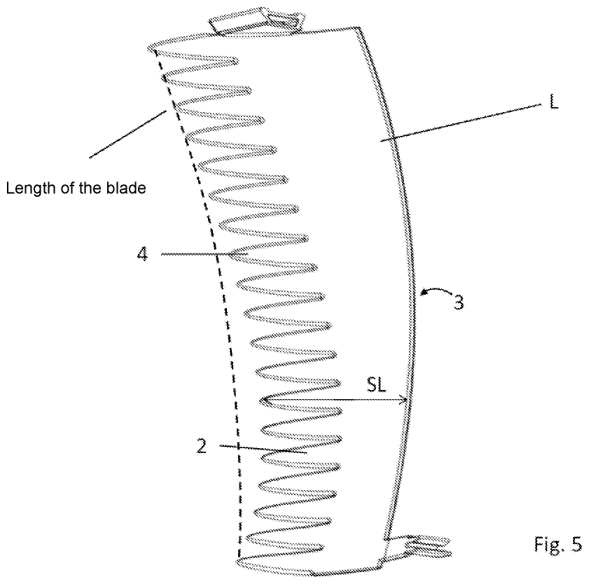

The spoilers L are attached to the inside of the central ring 10 (or a mounting body 10 as shown in the figures) and extend radially outward to a circumferential ring 11. A mounting flange 12 can also be provided on the circumferential ring 11, as is shown in the figures. The wavy leading edge 4 of a spoiler L has a plurality or multiplicity of periodically repeating corrugations, which can be seen clearly in the detailed view of FIG. 5, and in this exemplary embodiment runs along the entire length of the spoiler L.

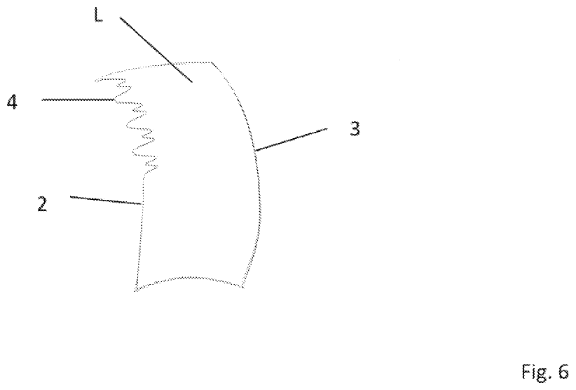

FIG. 6 shows a cut-out of an alternative spoiler L in which the leading edge 2, 4 has a wavy progression only in the portion with reference numeral 4 (thus partially).

The disclosure is not limited in its execution to the abovementioned preferred exemplary embodiments. Rather, a number of variants are conceivable which make use of the illustrated solution even in the form of fundamentally different embodiments.

1. A downstream guide device for a fan, wherein the downstream guide device has a plurality of spoilers, each with a leading edge and a trailing edge, whose airfoil profile is curved and/or twisted, each respective spoiler having a jagged or wavy leading edge with a periodically or non-periodically repeating waveform, at least in a portion.

2. The downstream guide device as set forth in claim 1, wherein the undulating pattern of the wave crests and wave troughs which is formed by the waveform extends substantially or completely in the plane formed by the spoiler in the vicinity of the leading edge and/or the wave crests extend substantially along a tangent along the surface of the spoiler in the vicinity of the respective wave crest.

3. The downstream guide device as set forth in claim 1, wherein the wavy leading edge of the spoilers has a plurality of identical or different wavy shapes which are each periodically repeated.

4. The downstream guide device as set forth in claim 1, wherein the waveform along the leading edge can be described according to one of the following mathematical functions:
a. a sinusoidal or near-sinusoidal waveform;
b. a power function of the nth order or nth degree, where −5≤n≤5.

5. The downstream guide device as set forth in claim 1, wherein the leading edge of the spoilers has a wavy or jagged edge shape substantially over the entire course of the length of the spoilers as viewed in the radial direction.

6. The downstream guide device as set forth in claim 4, wherein the leading edge of the spoilers has non-wavy edge profiles between or next to the wavy profiles, and has a plurality of identical or different wavy shapes which are each periodically repeated at least over a continuous portion.

7. The downstream guide device as set forth in claim 1, wherein the waveform is characterized by at least one of the following design measures:
A) the progression of the angle of attack has two or more inflection points over the radius;
B) a superposed variation of a periodic or non-periodic wave versus only an non-wavy continuous leading edge;
C) the chord length of the spoilers changes;
D) the airfoil sections are extended toward the leading edge, preferably continuously;
E) the curvature of the spoilers changes in the vicinity of the leading edge.

8. The downstream guide device as set forth in claim 1, wherein the waveform is formed on the leading edge in such a way that a wave crest is located at the end of the respective inner or outer leading edge.

9. The downstream guide device as set forth in claim 1, wherein the plurality of spoilers are arranged in a star shape at a central position.

10. A spoiler designed for a downstream guide device for a fan, wherein the spoiler is provided with a leading edge and a trailing edge, the spoiler having a jagged or wavy leading edge with a periodically repeating waveform in at least a portion as defined in claim 1.

11. An axial fan or diagonal fan with a slinger ring, further comprising a downstream guide device as set forth in claim 1 or one or more spoilers arranged downstream from the fan in the direction of flow as set forth in claim 10.

12. A diagonal fan or centrifugal fan with a shroud, further comprising a downstream guide device as set forth in claim 1 or one or more spoilers arranged downstream from the fan in the direction of flow as set forth in claim 10.

13. The axial fan or diagonal fan or centrifugal fan with a downstream guide device as set forth in claim 1.

14. The downstream guide device as set forth in claim 1, wherein the leading edge of the spoilers has a wavy or jagged edge shape over a continuous portion of more than 20% of the length of the spoilers as viewed in the radial direction.

15. The downstream guide device as set forth in claim 1, wherein the leading edge of the spoilers has a wavy or jagged edge shape over a continuous portion of more than 50% of the length of the spoilers as viewed in the radial direction.
